(19) United States
(12) Patent Application Publication
(10) Pub. No.: US 2007/0023584 A1
(43) Pub. Date: Feb. 1, 2007

(54) Railroad safety device

(76) Inventor: Lester Gryzbek, Palatine, IL (US)

Correspondence Address: WALLENSTEIN & WAGNER, LTD., 311 SOUTH WACKER DRIVE, 53RD FLOOR, CHICAGO, IL, 60606, US

(21) Appl. No.: 11/150,008

(22) Filed: Jun. 10, 2005

(51) Int. Cl. B61L 1/02; G09F 13/00; B61L 1/12

(52) U.S. Cl. 246/125; 40/541

(57) ABSTRACT

A railroad safety device is provided having a generally rectangular substrate, on which is disposed a plurality of indicator stripes, and at least two illuminated regions, wherein at least one of the illuminated regions is disposed at a terminal end of the substrate.

### TECHNICAL FIELD

The invention relates to a railroad safety device. More specifically, the present invention provides an improved railroad safety device comprising a substrate and a variety of safety indicia disposed on the substrate.

### BACKGROUND OF THE INVENTION

A number of railroad safety devices are known. For example, a standard railroad crossing arm comprises a substrate which is mechanically lowered to discourage vehicular traffic across a railroad. The crossing arm descends upon the mechanical sensing of an approaching train.

Some railroad safety devices include a plurality of vertical stripes disposed on the substrate, and in some designs the stripes are alternating colors to enhance the visibility of the device. Some of those systems are accompanied by lighting apparatus, which are positioned near the device. For example, a railroad-roadway intersection may feature a railroad crossing arm which extends from a vertically-aligned pole, positioned to the side of the roadway. Lighting apparatus, such as blinking red lights.

Automobile drivers are typically trained to observe that a blinking red light indicates a brief stop at an intersection, after which the motorist may safely proceed through an intersection. Therefore, railroad safety devices which include a blinking red light suffer from the disadvantage of indicating to a motorist that a brief stop, as opposed to a complete and full stop, is all that is required at the intersection.

Some safety systems include lights, positioned either atop or adjacent to the crossing arm, but those lights are not positioned on the crossing arm itself. Further, those flashing red lights are identical to the lights used at road intersections, indicating that after a brief stop a motorist may travel through the road intersection.

The present invention is provided to solve the problems discussed above and other problems, and to provide advantages and aspects not provided by prior railroad safety systems. A full discussion of the features and advantages of the present invention is deferred to the following detailed description, which proceeds with reference to the accompanying drawings.

### SUMMARY OF THE INVENTION

The present invention is directed to a railroad safety system comprising a substrate. Disposed on the substrate are a plurality of indicator stripes, a sign bearing the word “STOP”, a first illuminated region, and a second illuminated region disposed at a terminus of the substrate.

The present safety device comprises positive visual stimuli which make the device more visible to the motorists, and substantially discourage motorists from passing through a potentially unsafe railroad intersection.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is an illustration of a railroad safety device configured in accordance with the principles of the present invention;

FIG. 2 is an illustration of an alternate embodiment of a railroad safety device configured in accordance with the principles of the present invention; and,

FIG. 3 is an illustration of the interior of a railroad device configured in accordance with the principles of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

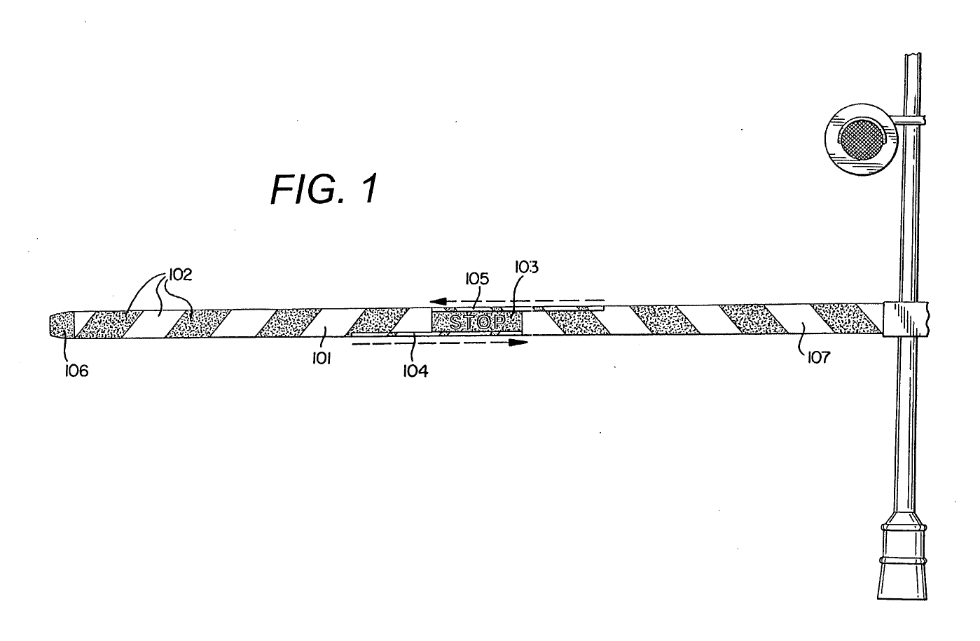

Referring initially to FIG. 1, a railroad safety device 101 is provided, and as illustrated, is in a preferred embodiment of a railway/roadway intersection crossing gate, intended to lower into an intersection to prevent through traffic when a train is approaching on the railway. The device 101 comprises a substrate 107, which is disposed vertically when not in use and horizontally, to bar traffic at an intersection, when deployed. The substrate 107 is preferably dimensioned so as to effectively bar traffic from entering an intersection when deployed. As illustrated, the preferred length of the substrate 107 is approximately ten feet, and the preferred width of the substrate 107 is approximately six inches. The preferred depth is approximately 2 inches. It will be understood that the substrate 107 is preferably sized to discourage motorist traffic from proceeding through a single lane of traffic, but that substrate 107 may optionally be sized to span two or more lanes of traffic as well, without departing from the principles of the present invention.

A plurality of indicator stripes 102 are disposed on the substrate 107. In a preferred embodiment, each of the plurality of indicator stripes 102 is colored either red or white, such that each stripe 102 is colored oppositely from the adjacent two stripes 102. For example, and as illustrated in FIG. 1, if a particular indicator stripe 102 is colored red, the adjacent two stripes 102 on either side of that stripe 102 will be colored white. It will be understood that the indicator stripes 102 are preferably comprised of highly reflective tape or paint, such that light directed at the stripes 102, e.g. the headlight of a car, will be reflected strongly back to the source of the light. In a preferred embodiment, each of the plurality of indicator stripes 102 is angled at approximately forty five degrees, wherein an upper portion of each of the plurality of indicator stripes 102 is angled toward the center portion of the substrate 107. As illustrated in FIG. 1, that angling of the stripes 102 causes the viewer's attention to be subconsciously drawn toward the center of the substrate 107.

A sign 103 bearing the word “STOP” is disposed on the substrate 107. The sign 103 is preferably approximately three inches tall and six to twelve inches wide, each of the letters of the word “STOP” being visible from at least twenty feet away from the device 101. The sign 103 is preferably disposed in the central portion of the substrate 107, as illustrated in FIG. 1, but may be disposed at any position of the substrate 107 in keeping with the principles of the present invention.

In a preferred embodiment, the sign 103 is comprised of illuminated lights, which are arranged to form the letters of the word “STOP”. It will be understood that the lights may be light bulbs, or may be diodes, either of which is activated upon the actuation of the device 101 into the traffic-blocking position. Likewise, the background portion of the sign 103, i.e., the portion of the sign 103 which is not the letters of the word “STOP”, may also be illuminated.

Also disposed on the substrate is a first illuminated region 104. In a preferred embodiment and as illustrated in FIG. 1, the first illuminated region 104 is preferably disposed at a central portion of the substrate 107, although the first illuminated region 104 may be disposed at any place on the substrate 107 in keeping with the principles of the present invention. The first illuminated region 104 is preferably a strobe light, which will be understood by one of skill in the art as a brightly flashing illuminated light. In a preferred embodiment and as illustrated in FIG. 1, first illuminated region 104 is shaped to form a strip of light drawing attention to the sign 103. First illuminated region 104 is preferably approximately one inch wide and four feet long. In a preferred embodiment and as illustrated in FIG. 1, first illuminated region 104 is comprised of individual component lights, which are disposed to be illuminated in order. As will be understood by one of skill in the art, that arrangement allows light in first illuminated region 104 to travel directionally within the region 104. Preferably, the light is arranged to travel toward the sign 103, drawing the viewer's attention to the sign 103.

As illustrated in FIG. 1, a third illuminated region 105 is preferably disposed on the substrate 107, accompanying first illuminated region 103. Third illuminated region 105 is preferably disposed opposite first illuminated region 103, such that the lights comprising third illuminated region 105 are disposed to make light appear to travel in a direction opposite to the direction light travels within first illuminated region 103. By and through that arrangement, sign 102 is disposed between first and third illuminated regions 103, 105 and surrounded by light from those regions and appearing to move toward sign 102.

A second illuminated region 106 is also disposed on the substrate 107. The second illuminated region 106 is preferably, and as illustrated in FIG. 1, disposed at a terminal end of the substrate 107, i.e., the end of the substrate furthest into the railway/roadway intersection. Second illuminated region 106 is thus positioned to illuminate the terminus of the substrate 107 and further discourage motor vehicle traffic from entering the intersection. Preferably, second illuminated region 106 is colored red. Second illuminated region 106 has a preferred height of six inches and a preferred width of three to six inches.

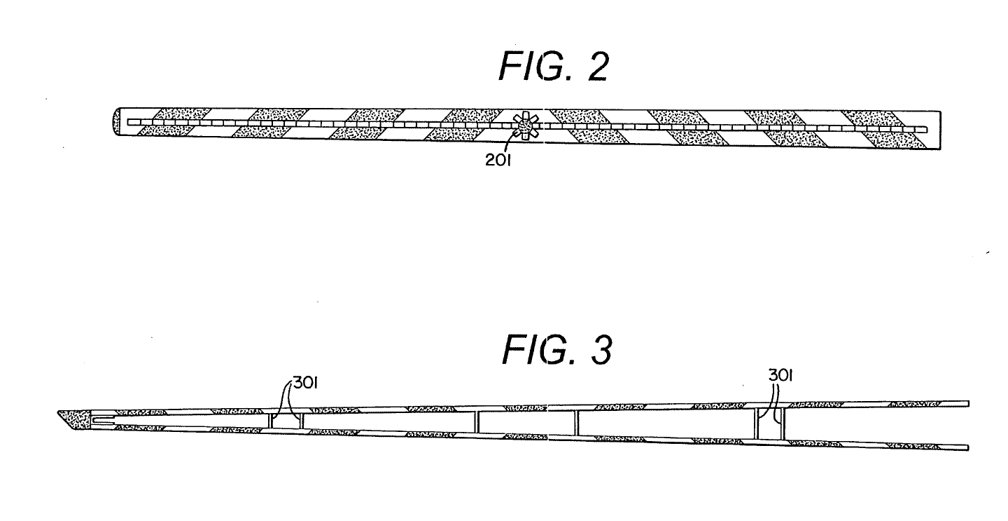

Referring now to FIG. 2, there is illustrated an alternate embodiment of the present invention, comprising a substrate 107, a plurality of indicator stripes 102, and first, second and third illuminated regions 104, 105 and 106 respectively. In this alternate embodiment, each of the plurality of indicator stripes 102 is arranged as in the preferred embodiment: alternating in color and angled approximately forty five degrees toward the center of the substrate 207. Second illuminated region 106 is also disposed at a terminal end of the substrate 207, as in the preferred embodiment. First and third illuminated regions 104, 105 are disposed, in the alternate embodiment and as illustrated in FIG. 2, adjacent to each other. It will be understood, by comparison between FIG. 1 and FIG. 2, that in both the preferred embodiment of FIG. 1 and the alternate embodiment of FIG. 2, first and third illuminated regions 104 and 105 are opposite each other. In the first embodiment, those regions 104, 105 are positioned vertically opposite, whereas in the second embodiment, those regions 104, 105 are positioned horizontally opposite. It will also be understood that in either embodiment, the individual component lights of illuminated regions 104, 105 are preferably arranged such that light appears to travel toward the center of the substrate 107.

As further illustrated in FIG. 2, in an alternate embodiment, a fourth illuminated region 201 is disposed on substrate 107. The fourth illuminated region 201 is preferably shaped as a star, as illustrated, and could alternatively be shaped as an octagon, or any other shape to draw the viewer's attention and indicate the necessity for the viewer to not enter the railway/roadway intersection. The fourth illuminated region 201 can be used, as illustrated, as a substitute for sign 103, but may also be used in addition to sign 103.

Referring now to FIG. 3, there is illustrated the internal construction of substrate 107. Brackets 301 are disposed vertically within the generally horizontal structure of substrate 107; i.e., perpendicular to the general alignment of substrate 107. Brackets 301 provide for structural support within the substrate 107. In a preferred embodiment, brackets 301 are each constructed of tubular housing, through which electrical feeds to the illuminated regions 103, 104, 105, 106 and 201 are passed. By and through that arrangement, the electrical feeds to those regions can be kept weather-proof and safe from the elements.

While the specific embodiments have been illustrated and described, numerous modifications come to mind without significantly departing from the spirit of the invention, and the scope of protection is only limited by the scope of the accompanying Claims.

What is claimed is:

1. A railroad safety device, comprising:
a substrate; and,
disposed on said substrate:
a plurality of indicator stripes;
a first illuminated region; and,
a second illuminated region disposed at a terminus of the substrate.

2. The device of claim 1, wherein a sign bearing the word “STOP” is disposed on the substrate.

3. The device of claim 2, wherein the sign is positioned in the horizontal center of the substrate.

4. The device of claim 2, wherein the sign is comprised of illuminated lights arranged to form the letters of the word “STOP”.

5. The device of claim 1, wherein the indicator stripes are colored red and white, each stripe being an alternate color of the adjacent stripe.

6. The device of claim 1, wherein the indicator stripes are comprised of reflective tape.

7. The device of claim 1, wherein each of the plurality of indicator stripes is vertically angled at approximately forty five degrees, wherein an upper portion of each of the plurality of indicator stripes is angled toward the center of the substrate.

8. The device of claim 1, wherein the first illuminated region is comprised of an illuminated strobe light.

9. The device of claim 1, further comprising a third illuminated region, wherein the first and third illuminated regions are each comprised of illuminated strobe lights, wherein the strobe light of the first region is disposed to travel in a direction opposite to the direction of the strobe light of the third region.

10. The device of claim 1, further comprising a forth illuminated region disposed at the horizontal center of the substrate.

11. The device of claim 1, wherein the interior of the substrate is comprised of a plurality of vertically disposed interior brackets.
